(19) United States
(12) Patent Application Publication
(10) Pub. No.: US 2021/0323077 A1
(43) Pub. Date: Oct. 21, 2021

(54) CONNECTION DEVICE

(71) Applicant: SAUTER FEINMECHANIK GMBH, Metzingen (DE)

(72) Inventors: Markus KOTZUR, Amberg (DE); Manfred SCHANZ, Reutlingen (DE)

(21) Appl. No.: 17/273,031

(22) PCT Filed: Sep. 6, 2019
(86) PCT No.: PCT/EP2019/073803

§ 371 Date: Mar. 3, 2021

(30) Foreign Application Priority Data
Sep. 7, 2018 (DE) 10 2018 007 084.1

(51) Int. Cl. B23B 31/26; B23Q 3/155

(52) U.S. Cl. CPC B23B 31/26; F16H 1/14; B23Q 3/1552

(57) ABSTRACT

A connection device for connecting a tool holder (4) to a drive unit (2), which are provided on adjacently opposite contact surfaces with a serration (124, 56) each, which can be brought into engagement with each other and having a retraction device (90, 118), which reduces an axial distance between the serrations (124, 56) until they are in contact with each other.

The invention relates to a connection device for connecting a tool holder to a drive unit, which are provided on adjacently opposite contact surfaces with a serration each, which can be brought into engagement with each other.

Connection devices of this type are state of the art. With particular advantage, such devices are used for connecting tool holders, which are used as holders for tools to be rotationally driven, to drive units of machine tools, in particular in tool turrets. In this respect, DE 42 28 946 A1 shows by way of example a spindle head for tool turrets having a serration formed as a splined shaft profile and formed on opposing contact surfaces, wherein said splined shaft profile meshes during the connection process. The known connection devices do not fully come up to the demands to be met in operation. To ensure a power transmission completely free of play, tight tolerances have to be provided for the fit of the serration. This in turn renders a quick and secure engagement of the serration difficult to achieve.

With regard to this difficulty, the invention addresses the problem of providing a connection device of the genus mentioned at the beginning, which is characterized by an, in comparison, optimized operational behavior.

According to the present invention, this problem is solved by a connection device having the features of claim 1 in its entirety.

Accordingly, the invention for establishing the serration engagement provides a retraction device, which reduces an axial distance between the serrations until they come into contact with each other. Because the connection process is mechanized in this way, the connection device according to the invention can be actuated without any problems even if the fit of the serrations is designed to be free of play.

In advantageous exemplary embodiments, the serrations each consist of a Hirth serration, which are axially braced against each other by means of the retraction device to achieve a complete frictional connection when in contact with each other. In this way any flank clearance can be completely eliminated, ensuring that the power transmission is completely free of play.

Advantageously, the arrangement can be such that the retraction device has a retraction part, which can be rotated by means of an actuating device and can be brought into engagement with an assigned stationary retracting part.

Advantageously, the arrangement is such that the rotatable retraction part is part of the drive unit, whereas the stationary retracting part is part of the tool holder. As a result, the rotary actuation of the retraction part can be advantageously implemented at the drive unit end. In particularly advantageous exemplary embodiments, both the retraction part and the retracting part have a multi-start thread that can engage with and disengage from each other. In this case, the thread engagement is effected by the rotary actuation of the retraction part, which is rotatably supported in the drive unit. Rotating engaged threads can generate large retraction forces.

In advantageous exemplary embodiments, the retraction part has a threaded bushing having a female thread, wherein said threaded bushing is rotatably guided in a receptacle of the drive unit, wherein the actuating device has a drive wheel, in particular in the form of a bevel gear, which is rotatably guided in the drive unit, the gearing of which meshes with a spur gear of the threaded bushing. Because the threaded bushing is mounted coaxially to the axis of the drive unit to generate an axial retraction and can be rotated by means of a bevel gear transmission, this results in an axis of rotation for the bevel gear to be actuated that is perpendicular to the drive axis. Advantageously, in this way, the bevel gear at the drive unit can be laterally accessible from the outside and can be rotated manually from the outside for the retraction process.

In advantageous exemplary embodiments, ring segments are used to support the rotatably guided threaded bushing in the direction of the tool holder, wherein of said ring segments the one that is located at the position of the bevel gear has a recess for the passage of the bevel gear.

Advantageously, a locating ring in the receptacle of the drive unit is used to hold the respective ring segments on their ends facing away from the threaded bushing and wherein said ring segments are secured against rotation by at least one threaded pin. For axial support of the locating ring, a step reaching over the locating ring can be formed on the receptacle of the drive unit, wherein the locating ring can be formed as a slotted ring to enable insertion below the step.

For driving a tool holder provided for a rotary tool, such as a drill or reamer, the drive unit can have a drive spindle rotatably mounted in a housing, wherein said drive spindle has the retraction part and one of the Hirth serrations on its free end face.

For use with a tool turret, the housing may have a contact surface which can be fixed to the mounting surface on a work station of a concerning tool disk, wherein a hollow shaft projecting axially from the contact surface is provided, wherein through said hollow shaft the drive spindle, when in position on the tool disk, extends into the interior of the tool disk and achieves a driving connection with the internal drive of the tool disk.

The tool holder can be rotatably driven via its Hirth serration by the drive spindle via the latter's Hirth serration. To this end, the thread of the tool holder in the form of a male thread is at least partially engaged with the female thread of the threaded bushing of the drive unit.

Below the invention is explained in detail with reference to an exemplary embodiment shown in the drawing. In the Figures:

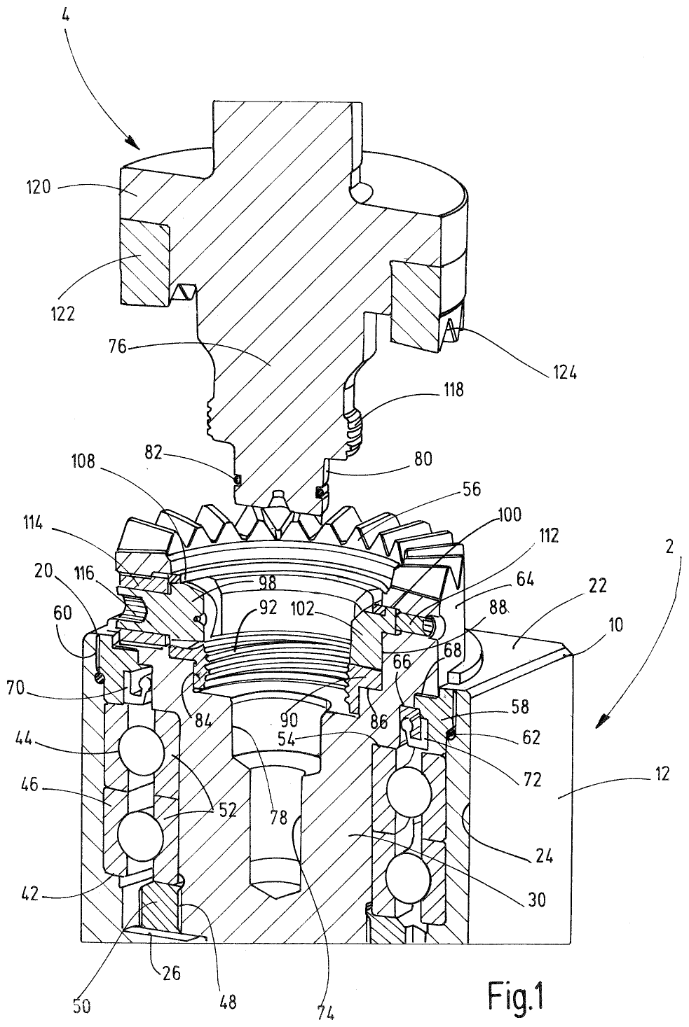

FIG. 1 shows a perspective oblique view, sectioned in a central vertical plane, of the exemplary embodiment of the connection device according to the invention, wherein the schematically simplified tool holder is shown in a position lifted off the drive unit and the drive unit is shown cut-off;

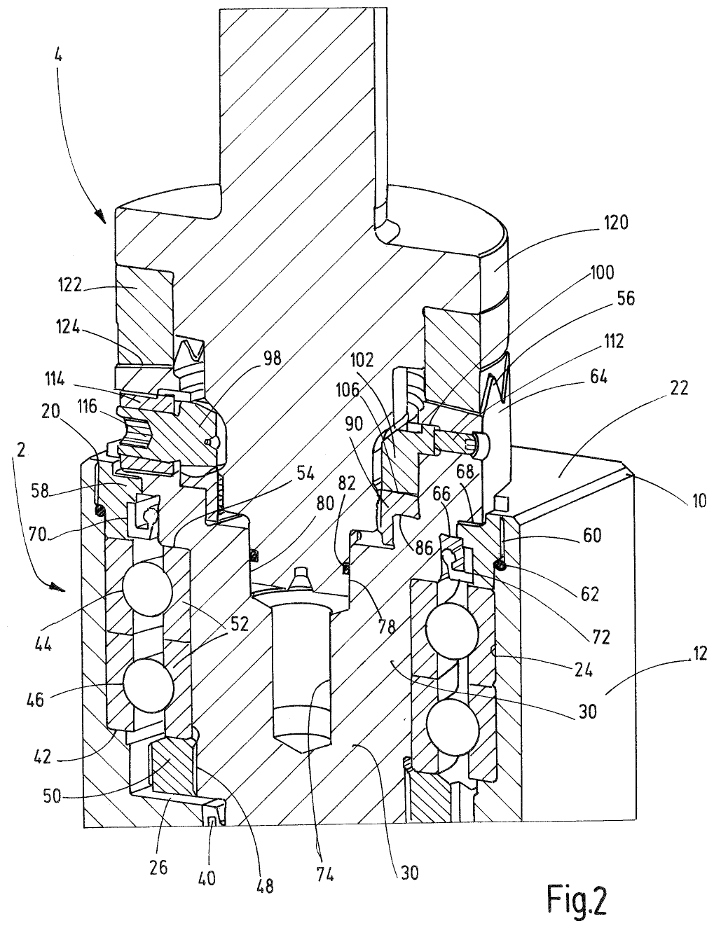

FIG. 2 shows an enlarged and cut-off view, sectioned in accordance with FIG. 1, of the upper part of the exemplary embodiment, wherein the tool holder is shown in the position connected to the drive unit;

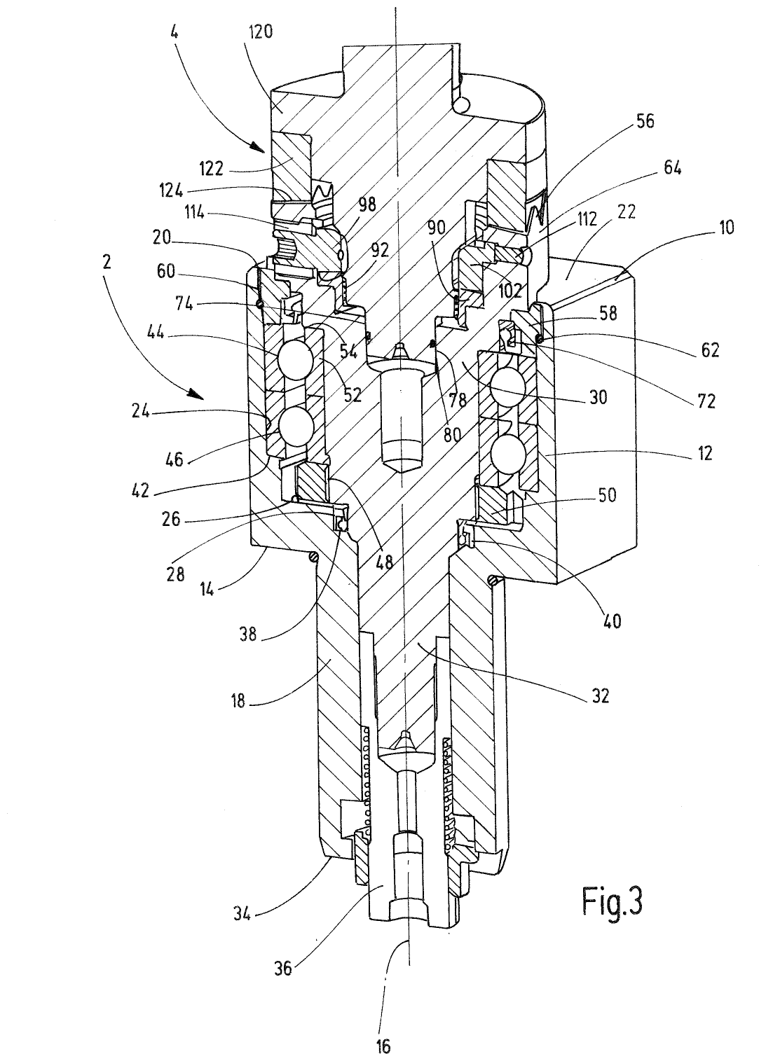

FIG. 3 shows a view, sectioned corresponding to FIGS. 1 and 2, wherein the drive unit is shown in its entirety; and

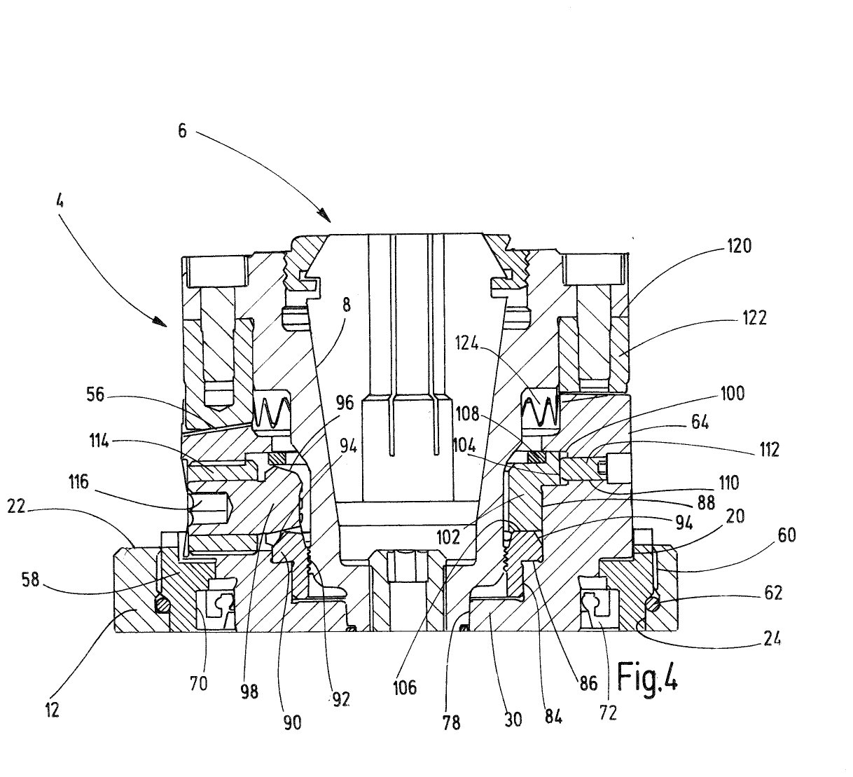

FIG. 4 shows a partial longitudinal section of the exemplary embodiment, showing only the upper end area of the drive unit together with the tool holder is in the connected position.

The exemplary embodiment shown in the drawing is provided for connecting a drive unit 2 to a tool holder 4 for a tool that can be rotationally driven, such as a drilling tool or a milling tool (not shown). FIGS. 1 to 3 show the tool holder 4 in simplified form without the holder for the tool to be held. In this respect only FIG. 4 shows a tool holder 6 of conventional construction having an inner cone 8. As can best be seen from FIG. 3, in which the drive unit 2 is shown in its entirety, it has a housing 10 having an upper main housing part 12, which is cube-shaped. The flat bottom of the main part 12 forms a contact surface 14, which can be used to fix the housing 10 to the receiving surface of a tool station on the tool disk (not shown) of a tool turret. Coaxially to the longitudinal axis of the device 16 (FIG. 3) a hollow shank 18 extends away from the contact surface 14, wherein said hollow shank 18 projects, when in position on a tool disk, into the interior of the tool disk. Starting from an opening 20 in its planar top 22, the main body part 12 has an inner cylinder 24 coaxial with the axis 16, delimited at its lower end by a bottom surface 26 located in a radial plane, wherein in said bottom surface 26 an opening 28, the diameter of which is smaller than that of the upper opening 20, forms the transition from the inner cylinder 24 to the interior of the hollow shaft 18. The drive-end shaft journal 32 of a drive spindle 30, rotatably supported in the main body 12, extends through the lower opening 28 and the interior of the hollow shaft 18 beyond the latter's free end 34. A coupling part 36 located at the projecting end of the spindle engages, when in a position attached to the tool disk, with the tool drive in the manner usual for tool turrets.

As FIG. 3 shows, the outer diameter of the shaft journal 32 in the hollow shaft 18 is smaller than the diameter of the part of the drive spindle 30 adjoining in the main part 12. Corresponding to this reduction in diameter, the inner diameter of the opening 28 is reduced by a step 38. This step 38 forms the seat for a shaft seal 40, which forms the housing seal of the drive spindle 30 at the transition to its shaft journal 32. The diameter of the inner cylinder 24 in the main part 12 is also stepped and has a shoulder surface 42 at an axial distance from the bottom surface 26, wherein said axial distance is approximately ⅙ of the axial depth of the inner cylinder 24, wherein on said shoulder surface 42 the inner diameter decreases to the diameter of the bottom surface 26. When assembling the drive unit 2, the drive spindle 30 together with precision roller bearings 44, 46 is inserted into the inner cylinder 24 from the upper opening 28.

The drive spindle 30 has, prior to the transition to the tapered shaft journal 32, a male thread 48 for a threaded ring 50, by which the inner rings 52 of the precision roller bearings 44, 46 are clamped against a shoulder surface 54. It forms the transition to further steps on the drive spindle 30, wherein said steps widen both the inner diameter and the outer diameter of the drive spindle 30 up to the upper end, where the end face on the upper end of the drive spindle 30 forms a Hirth serration 56, as can be seen most clearly in FIG. 1. After insertion into the inner cylinder 24, the structural unit of the drive spindle 30 and roller bearings 44, 46 fixed thereon is secured in its installed position by another threaded ring 58 screwed into a female thread 60 in the main part 12, wherein a gasket 62 forms the seal. The threaded ring 58 resting against the outer ring of the roller bearing 44, holds the outer ring of the roller bearing 46 in contact with the shoulder surface 42 of the main housing part 12 to secure the mounting position.

The outer circumference of the drive spindle 30 is cylindrical in the area between the male thread 48 and the shoulder surface 54 against which the inner ring 52 of the roller bearing 44 rests. From the shoulder surface 54 upward, the outer diameter increases in further steps until the end section 64, which has the largest outer diameter and is circular cylindrical. The front end of the end section 64, as can be seen most clearly from FIG. 1, forms the Hirth serration 56 in the form of a circular ring. Above the shoulder surface 54, the outer diameter increases in two further superimposed steps 66 and 68 towards the end section 64 having the largest outer diameter, see FIG. 2. In the area between the step 66 and the shoulder surface 54, a recess 70 is formed in the threaded ring 58, wherein said recess 70, together with the circumferential area of the spindle 30 located below the step 66, forms the seat for a shaft seal 72.

The drive spindle 30 has an internal space in the form of a coaxial blind hole 74 extending from the upper open end, at which the Hirth serration 56 on the front end encompasses the opening of the drilled hole as a serration ring. The inner diameter of the drilled hole 74 is stepped in a manner similar to the stepping of the outer diameter of the spindle 30. The blind hole 74 is provided for receiving a journal 76 of the tool holder 4, the outer diameter of which has a stepped shape matching the stepping of the blind hole 74. The blind hole 74 has a circular cylindrical drilled hole section 78, see FIG. 1, at a distance from the closed end of the drilled hole, with which a circular cylindrical end part 80 of the journal 76 of the tool holder 4 engages to fit when in the inserted position, wherein a sealing ring 82 forms the seal.

The matching guide of the end part 80 in the circular cylindrical drilled hole section 78 is used to center the tool holder 4 when it is being inserted into the receptacle formed by the blind hole 74 in the spindle 30 for a retracting process. Above the drilled hole section 78, as most clearly shown in FIG. 4, the drilled hole 74 merges into a first enlarged wall section 84 and, at a shoulder 86 above, into a wall section 88 further enlarged in inner diameter. The shoulder 86 and the wall sections 88 form the rotary bearing for a threaded bushing 90, which forms the retraction part for the retracting process. The threaded bushing 90 has a female thread 92 and a bevel gear toothing 94 on the outer rim of the end face. The bevel gear toothing 94 meshes with the toothing 96 of a bevel gear 98, as detailed below, see FIG. 4.

As this Figure shows most clearly, an annular groove 100 forming a radial depression is located in the wall section 88. The annular groove 100 is used to axially secure three ring segments 102 (only one visible), which rest against the wall section 88 and which have a radially outwardly projecting ring edge 104, with which they engage with the annular groove 100. The lower end rim 106 of the ring segments 102 abuts the end face of the threaded bushing 90 and thereby provides support for the threaded bushing 90 against being lifted off from the shoulder 86 by the retraction force acting in the axial direction. To secure the ring segments 102 in the annular groove 100 when the tool holder 4 is not inserted a securing ring 108 is provided, which is formed as a slotted ring, which can reach beneath the edge of the annular groove 100. To secure the ring segments 102 against rotation, a threaded hole 110 for a threaded pin 112 is formed in the end section 64, wherein said threaded pin 112 engages an axially extending groove in the ring edge 104 of the concerning ring segment 102.

As indicated, a bevel gear 98 is provided for actuating the threaded bushing 90, wherein said bevel gear 98 is rotatably supported in a bearing bushing 114 about an axis of rotation perpendicular to the longitudinal axis 16 of the device and is accessible for rotational actuation by means of a hexagon socket 116 at the exterior of the housing. A male thread 118 is provided on the journal 76 of the tool holder 4 as the retracting part of the retraction device for interaction with the female thread 92 of the threaded bushing 90, wherein said male thread 118 engages with the female thread 92 of the threaded bushing 90 when the tool holder 4 is inserted. By rotating the bevel gear 98 and by the resulting rotational motion of the threaded bushing 90 generated via the bevel gear transmission, the male thread 118 on the shaft 76 is screwed into the threaded bushing 90, in that way pulling the tool holder 4 into the mount of the spindle 30.

At its outer circumference the tool holder 4 is circular-cylindrical, wherein the outer circumference is composed of a support ring 120 and a Hirth serration ring 122 adjoining the support ring 120 in the direction of the drive unit, which extends the outer circumference of the support ring without an offset. The Hirth serration ring 122 has a Hirth serration 124 on the end face facing away from the support ring 120, wherein said Hirth serration 124 matches the Hirth serration 56 on the drive spindle 30 of the drive part 2. The Hirth serration ring 122 may be bolted or bonded to the support ring 120, as shown in FIG. 4. The outer diameter of the Hirth serration ring 122 matches the outer diameter of the end area 64. During the retraction motion by the retraction force generated by the rotation of the threaded bushing 30 in thread engagement with the male thread 118 of the tool holder 4, the Hirth serration 124 of the tool holder 4 is pulled together with the Hirth serration 56 of the spindle 30, wherein any backlash is eliminated by the retraction force generated, in that way forming a connection, which ensures a power transmission completely free of play. In the figures, the solution according to the invention is shown as a linear wheel drive; however, angular tool holders can also be operated using the same locking and drive concept.

1. A connection device for connecting a tool holder (4) to a drive unit (2), which are provided on adjacently opposite contact surfaces with a serration (124, 56) each, which can be brought into engagement with each other and having a retraction device (90, 118), which reduces an axial distance between the serrations (124, 56) until they are in contact with each other.

2. The connection device according to claim 1, characterized in that the serrations each consist of a Hirth serration (124, 56), which are axially braced against each other by means of the retraction device (90, 118) to achieve a complete frictional connection when in contact with each other.

3. The connection device according to claim 1, characterized in that the retraction device has a retraction part (90), which can be rotated by means of an actuating device (98) and can be brought into engagement with an assigned stationary retracting part (118).

4. The connection device according to claim 1, characterized in that the rotatable retraction part (90) is part of the drive unit (2) and the stationary retracting part (118) is part of the tool holder (4).

5. The connection device according to claim 1, characterized in that both the retraction part (90) and the retracting part (118) have a multi-start thread that can engage with and disengage from each other.

6. The connection device according to claim 1, characterized in that the retraction part has a threaded bushing (90) having a female thread, wherein said threaded bushing (90) is rotatably guided in a receptacle (74) of the drive unit (2), and in that the actuating device has a drive wheel, in particular in the form of a bevel gear (98), which is rotatably guided in the drive unit (2) and the gearing of which meshes with a spur gear of the threaded bushing (90).

7. The connection device according to one of the preceding claims claim 1, characterized in that ring segments (102) are used to support the rotatably guided threaded bushing (90) in the direction of the tool holder (4), wherein of said ring segments the one that is located at the position of the bevel gear (98) has a recess for the passage of the bevel gear (98).

8. The connection device according to claim 1, characterized in that a locating ring (108) in the receptacle (74) of the drive unit (2) is used to hold the respective ring segments (102) on their ends facing away from the threaded bushing (90) and in that said ring segments (102) are secured against rotation by at least one threaded pin (112).

9. The connection device according to claim 1, characterized in that the drive unit (2) has a drive spindle (30) rotatably supported in a housing (10), wherein said drive spindle (30) has the retraction part (90) and one of the Hirth serrations (56) on its free end face.

10. The connection device according to claim 1, characterized in that the tool holder (4) can be rotatably driven via its Hirth serration (124) by the drive spindle (30) via the latter's Hirth serration (56), and in that the male thread (118) of the tool holder (4) is at least partially engaged with the female thread (92) of the drive unit (2).
